(19) United States
(12) Patent Application Publication
(10) Pub. No.: US 2005/0138276 A1
(43) Pub. Date: Jun. 23, 2005

(54) Methods and apparatus for high bandwidth random access using dynamic random access memory

(75) Inventors: Muraleedhara H. Navada, Santa Clara, CA (US); Rohit R. Verma, San Jose, CA (US); Miguel A. Guerrero, Fremont, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/742,021

(22) Filed: Dec. 17, 2003

(51) Int. Cl. G06F 12/00

(52) U.S. Cl. 711/105

(57) ABSTRACT

The inventive subject matter provides various apparatus and methods to perform high-speed memory read accesses on dynamic random access memories (“DRAMs”) for read-intensive memory applications. In an embodiment, at least one input/output (“I/O”) channel of a memory controller is coupled to a pair of DRAM chips via a common address/control bus and via two independent data busses. Each DRAM chip may include multiple internal memory banks. In an embodiment, identical data is stored in each of the DRAM banks controlled by a given channel. In another embodiment, data is substantially uniformly distributed in the DRAM banks controlled by a given channel, and read accesses are uniformly distributed to all of such banks. Embodiments may achieve 100% read utilization of the I/O channel by overlapping read accesses from alternate banks from the DRAM pair.

### TECHNICAL FIELD

The inventive subject matter relates generally to dynamic random access memory (DRAM) and, more particularly, to apparatus to provide high-speed random read access, and to methods related thereto.

### BACKGROUND INFORMATION

High-speed networks increasingly link computer-based nodes throughout the world. Such networks, such as Ethernet networks, may employ switches and routers to route data through them. It is desirable that network switches and routers operate at high speeds and that they also be competitively priced.

High-speed switches and routers may employ data structures, such as lookup tables (also referred to herein as “address tables”), to store and retrieve source addresses and destination addresses of data being moved through a network. The source and destination addresses may relate to data packets being sent from a network source to one or more network destinations. High-speed switches and routers need to perform frequent lookups on address tables. The lookup operations are read-intensive and must generally be performed at very high speeds.

In addition, the addresses may be random in nature, so that they may be mapped to any arbitrary location in memory. Further, relatively large address table sizes are needed for high-capacity switches.

Current high-speed switches and routers store address tables either on-chip or in off-chip memories. The off-chip memories can be static random access memories (“SRAMs”) or dynamic random access memories (“DRAMs”).

SRAMs provide random access at very high speeds. However, SRAMs are relatively higher in cost than DRAMs. SRAM-based memory systems also typically suffer from lower memory density and higher power dissipation than DRAM-based memory systems.

For the reasons stated above, and for other reasons stated below which will become apparent to those skilled in the art upon reading and understanding the present specification, there is a significant need in the art for apparatus, systems, and methods that provide high-speed random access reads and that are relatively low cost, relatively dense, and relatively power-efficient.

### BRIEF DESCRIPTION OF THE DRAWINGS

FIG. 1 is a block diagram illustrating a high-speed DRAM system, in accordance with an embodiment of the invention;

FIG. 2 is a block diagram of a computer system incorporating a high-speed DRAM system, in accordance with an embodiment of the invention;

FIG. 3 is a block diagram of a computer network that includes a high-speed DRAM system, in accordance with an embodiment of the invention; and

FIGS. 4A and 4B together comprise a flow diagram illustrating various methods of accessing memory in a computer system, in accordance with various embodiments of the invention.

### DETAILED DESCRIPTION

In the following detailed description of embodiments of the inventive subject matter, reference is made to the accompanying drawings that form a part hereof, and in which is shown by way of illustration specific preferred embodiments in which the inventive subject matter may be practiced. These embodiments are described in sufficient detail to enable those skilled in the art to practice the inventive subject matter, and it is to be understood that other embodiments may be utilized and that structural, mechanical, compositional, electrical, logical, and procedural changes may be made without departing from the spirit and scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed. The following detailed description is, therefore, not to be taken in a limiting sense, and the scope of the inventive subject matter is defined only by the appended claims.

Known SRAM-based switches and routers allow up to 100% read utilization of the input/output interface channels between the on-chip memory controller and the SRAM system. However, known DRAM-based designs cannot achieve 100% read utilization, due to precharge and activation operations needed by banks.

The inventive subject matter provides for one or more methods to enable SRAM-like read access speeds on DRAMs for read-intensive memory applications. Embodiments of the inventive subject matter pertain to DRAM memory that is located on a separate chip from the memory controller.

Embodiments of the inventive subject matter have DRAM advantages with SRAM performance. In embodiments, higher read performance is traded off against lower write access speeds.

The inventive subject matter enables embodiments to achieve 100% utilization of channels during read access. This may reduce the total channel requirement and the total system cost.

Various embodiments of apparatus (including circuits, computer systems, and network systems) and associated methods of accessing memory will now be described.

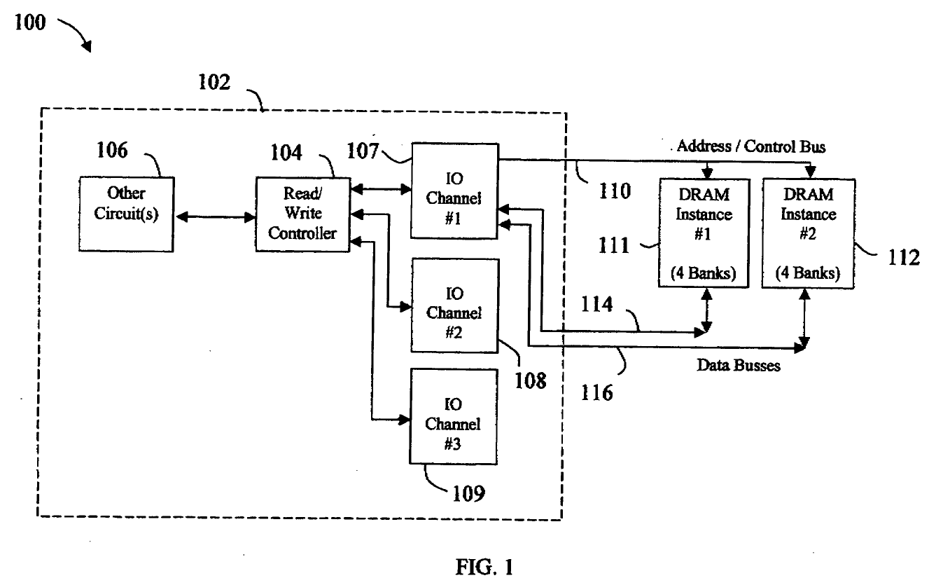

FIG. 1 is a block diagram illustrating a high-speed DRAM system 100, in accordance with an embodiment of the invention. In the embodiment illustrated, DRAM system 100 comprises an ASIC (Application Specific Integrated Circuit) 102 coupled to a group of two DRAMs 111 and 112. Each DRAM 111-112 may comprise four internal banks.

ASIC 102 comprises a memory read/write controller 104 (also referred to herein simply as a “memory controller”) to control memory read and write operations in DRAMs 111-112. Read/write controller 104 controls one or more I/O (input/output) channels 107-109. A “channel” is defined herein to mean a group of address, control, and data busses coupled between a memory controller and a group of one or more DRAMs being controlled by the memory controller. For example, regarding the embodiment shown in FIG. 1, an off-chip address/control bus 110 is coupled between read/write controller 104 and each of DRAMs 111-112 through a first I/O channel 107. In an embodiment, address/control bus 100 is 22 bits wide. However, the inventive subject matter is not limited to any particular configuration of address and/or control busses.

In addition, first and second off-chip data busses 114 and 116, respectively, are coupled between read/write controller 104 and DRAMs 111-112, respectively, through I/O channel 107. In an embodiment, each data bus 114 and 116 is 24 bits wide. Each data bus 114, 116 may also include additional bits (e.g. 4 bits in an embodiment) for error detection and correction.

In an embodiment, ASIC 102 controls three independent channels 107-109, and each channel 107-109 is coupled to a separate group of two DRAM instances (e.g. DRAMs 111-112). For simplicity of illustration, the groups of DRAM instances that would be coupled to 10 channels 108 and 109 are not shown in FIG. 1. For each channel 107-109, the address/control bus (e.g. address/control bus 110 associated with channel 107 in FIG. 1) is shared in common by the two DRAM instances, but each DRAM instance has its own data bus (e.g. data busses 114, 116 associated with channel 107 in FIG. 1).

Still with reference to ASIC 102, read/write controller 104 may also be coupled to one or more other circuits 106, such as suitable read/write sequencing logic and address mapping/remapping logic, which may be located either on or off ASIC 102.

“Suitable”, as used herein, means having characteristics that are sufficient to produce the desired result(s). Suitability for the intended purpose can be determined by one of ordinary skill in the art using only routine experimentation.

Different architecture could be employed for the DRAM system 100 in other embodiments. For example, more or fewer than three channels controlling three groups of DRAM pairs could be used. Also, more or fewer than two DRAM instances per group could be used. Also, more or fewer functional units could be implemented on ASIC 102. Also, multiple ASICs, integrated circuits, or other logic elements could be employed in place of or in conjunction with ASIC 102.

In the following description, the term “instance” refers to an architectural or organizational unit of DRAM. In an embodiment, each instance is implemented with a single integrated circuit device or chip. For example, DRAM 111 and DRAM 112 may be referred to herein as Instance #1 and Instance #2, respectively.

In the embodiment illustrated in FIG. 1, each DRAM instance comprises four internal memory banks. However, the inventive subject matter is not limited to any particular DRAM architecture, and DRAMs having more than or fewer than four memory banks may be employed.

Each DRAM bank comprises at least one address bus, whose width depends upon the size of the memory. For example, a one-megabyte memory would typically have a 20-bit address bus.

Each DRAM bank also comprises at least one data bus, whose width depends upon the particular size of words stored therein. For example, if 32 bits are stored per memory location, a 32-bit data bus may be used. Alternatively, an 8-bit data bus could be used if a 4-cycle read/write access is performed.

In an embodiment, more than one instance can share the same address/control bus 110, as shown in FIG. 1. However, the inventive subject matter is not limited to using a common address/control bus, and in other embodiments each DRAM instance may have its own address/control bus. Also, in other embodiments, the address and control lines could be dedicated lines and not shared by both address and control signals.

Further, in an embodiment, each instance may comprise its own data bus 114 or 116, as shown in FIG. 1.

In an embodiment, DRAM Instance #1 and #2 may each contain several banks with access times of several cycles. For example, a typical DDR (double data rate) DRAM device operating at 250 MHz (megahertz) needs sixteen cycles for a read/write access of a bank.

Known commercially available DRAMs typically operate in accordance with various constraints. For example, each bank has mandatory “overhead” operations that must be performed.

Such mandatory operations typically include bank/row activation (also known as “opening” the row). Before any READ or WRITE commands can be issued to a bank within a DDR DRAM, a row in that bank must be “opened” with an “active” or ACTIVATE command. The address bits registered coincident with the ACTIVATE command may be used to select the bank and row to be accessed.

Following the ACTIVATE command (and possibly one or more intentional NOP's (no operation)), a READ or WRITE command may be issued. The address bits registered coincident with the READ or WRITE command may be used to select the bank and starting column location for a burst access. A subsequent ACTIVATE command to a different row in the same bank can only be issued after the previous active row has been “closed” (precharged). Moreover, there is a mandatory wait period between accessing different banks of the same instance. However, a subsequent ACTIVATE command to a second bank in a second instance can be issued while the first bank in the first instance is being accessed.

The mandatory operations also typically include a “closing” operation, which may include precharging. Precharge may be performed in response to a specific precharge command, or it may be automatically initiated to ensure that precharge is initiated at the earliest valid stage within a burst access. For example, an auto precharge operation may be enabled to provide an automatic self-timed row precharge that is initiated at the end of a burst access. A bank undergoing precharge cannot be accessed until after expiration of a specified wait time.

For known DDR DRAM systems, these mandatory operations, including “opening” and “closing” operations, represent significant overhead on any access, and they reduce the throughput and lower the overall bandwidth. The inventive subject matter provides a solution to the problem of enabling SRAM-like access speeds on DRAMs, as will now be discussed.

The inventive subject matter provides a technique to optimize read accesses in a DDR DRAM system by duplicating the data in several DRAM banks. It will be understood by those of ordinary skill in the art that, due to the data duplications, the write access efficiency will be reduced somewhat. However, because most memory accesses are read operations, overall efficiency is high.

Before discussing the operation of DRAM system 100 (FIG. 1), the data organization of one embodiment will be briefly discussed. The data contents or data structures (e.g. address lookup tables) may be mapped to DDR-DRAM memories according to available DRAM devices. For example, if the data structures (e.g. address lookup tables) are 64 bits wide, a DDR-DRAM device with a 16-bit data bus may be chosen with a 4-cycle burst read operation. So that device would return 64 bits with one READ command.

### Operation

The data (e.g. address lookup tables) is duplicated in all of the eight banks of the first group of DRAMs (i.e. DRAMs 111-112). In an embodiment, a duplicator agent may be used to duplicate the data in all of the eight banks. One of ordinary skill in the art will be capable of implementing a suitable duplicator agent. The banks of more than one DRAM instance (i.e. Instance #1 or Instance #2) may be written to concurrently, in an embodiment, depending upon the constraints of the particular DRAM devices/system.

As mentioned earlier, a particular command sequence typically controls the operation of DDR DRAM devices. This command sequence may comprise (1) an ACTIVATE or “open bank” command; (2) a “read-write access” command, which may involve read and/or write operations on one or more organization units (e.g. pages) of the DRAM device, and which may consume a significant amount of time; and (3) a “closing” or “precharge” command, which may involve a precharge operation. These commands and operations are mentioned in the description below of the Timing Diagram.

To achieve maximum read access throughput, the individual banks of a group may be opened, accessed, and closed in a sequential manner, as illustrated in the Timing Diagram provided below.

### Timing Diagram

//The first row represents sequential clock cycles within DRAM system 100 (FIG. 1). //Rows 2-5 represent various commands and operations on banks 1-4, respectively, of //a first DRAM device (e.g., Instance #1), and rows 6-9 represent various commands and //operations on banks 1-4, respectively, of a second DRAM device (e.g., Instance #2). //The “A” and “R” commands given to either of the two DRAM devices don't //overlap, and the data bus from each DRAM device is fully occupied.

01234567890123456789012345678901234567890123456789012345678901234567890
A----Rrrr-p----,A----Rrrr-p----,A----Rrrr-p----,A----Rrrr-p----,A
,---A----Rrrr-p----,A----Rrrr-p----,A----Rrrr-p----,A----Rrrr-p----,A
,,------A----Rrrr-p----,A----Rrrr-p----,A----Rrrr-p----,A----Rrrr-p
,,,---------A----Rrrr-p----,A----Rrrr-p----,A----Rrrr-p----,A----Rrrr-p
,,A----Rrrr-p----,A----Rrrr-p----,A----Rrrr-p----,A----Rrrr-p----,A
,,,---A----Rrrr-p----,A----Rrrr-p----,A----Rrrr-p----,A----Rrrr-p----,A
,,,,------A----Rrrr-p----,A----Rrrr-p----,A----Rrrr-p----,A----Rrrr-p
,,,,,---------A----Rrrr-p----,A----Rrrr-p----,A----Rrrr-p----,A----Rrrr

The following notations are used in the Timing Diagram:
“A”=ACTIVATE command (opening of bank)
“-”=Required NOP (no operation) cycle
“R”=READ command
“r”=Burst READ operation
“p”=AUTO PRECHARGE command, transparent to user (closing of bank)
“,”=Intentional NOP cycle

The operation of an embodiment of the DRAM system will now be explained with reference to the above Timing Diagram.

As mentioned earlier, the DRAMs 111 and 112 operating at 250 MHz need sixteen cycles for a read/write access of a bank. This may be seen in the Timing Diagram wherein, for example, sixteen cycles occur between successive ACTIVATE commands to any given bank.

At time slot or cycle 0, the memory controller (e.g. read/write controller 104, FIG. 1) issues an ACTIVATE command to the first bank of Instance #1, and the first bank undergoes an activate operation during time slots 1-4.

At time slot 5, the memory controller issues a READ command to the first bank of Instance #1, and it undergoes a burst read operation during time slots 6-8.

At time slot 9, an intentional NOP is inserted.

At time slot 10, the first bank of Instance #1 executes an AUTO PRECHARGE command, and it undergoes a closing operation during time slots 11-14.

At time slot 15, an intentional NOP is inserted. The purpose of this intentional NOP is to properly align the timing of commands, so that two commands do not conflict with one another on the shared address/control bus.

At time slot 16 the memory controller issues an ACTIVATE command to the first bank of Instance #1, and it undergoes an ACTIVATE operation during time slots 17-20. At the conclusion of time slot 20, a closing (e.g. precharging) operation will have been completed on the first bank of Instance #1, and it will be ready for another read access in time slot 21. The operation of the first bank of Instance #1 continues in a similar fashion.

The operation of the second, third, and fourth banks of Instance #1, and of the first through fourth banks of Instance #2 may similarly be understood from the Timing Diagram.

It will be observed from the Timing Diagram that during any given time slot, overlapping read accesses may occur. For example, during time slots 7-8, read access operations are occurring concurrently for the first bank of Instance #1 and the first bank of Instance #2. During time slots 9-10, read access operations are occurring concurrently for the second bank of Instance #1 and the first bank of Instance #2. During time slots 11-12, read accesses are occurring concurrently for the second bank of Instance #1 and the second bank of Instance #2.

A read request from the memory controller over IO channel 107 can be serviced by any bank in the group of DRAMs 111-112. Any read access issued by the memory controller over IO channel 107 will have at least one bank to read from. The redundant data in all of the banks in the group of DRAMs 111-112 allows real random access for read operations. Moreover, the access time becomes fixed irrespective of the overhead states (“opening” or “closing”) of any bank. This arrangement ensures having at least one bank in a group available for read at any time.

A side effect of this arrangement is lower write efficiency, as a write operation needs to be performed on all of the banks of a group before such write operation is declared to be complete. In an embodiment of the inventive subject matter, memory reads typically consume approximately 90% of the time, and memory writes consume approximately 10% of the time. A write operation may be required, for example, when data (e.g. address lookup tables) are updated, e.g. when a new address is learned or when one or more addresses are “aged out” by a suitable aging mechanism.

Duplication of the data across multiple DDR DRAM banks reduces the memory density. However, because DRAM density is typically more than four times that of SRAM, the overall cost is lower. In this arrangement, the duplication factor is dependent upon various factors, including the nature of a single bank and the device bit configuration.

In general, for bursty access DRAM banks normally consume a fewer number of cycles on the address/control bus than on their associated data bus. This means that a fewer number of commands on the address/control bus are needed to generate a relatively greater number of data cycles. For example, in an embodiment, a DDR DRAM needs two command cycles on the address/control bus to generate four data cycles. The inventive subject matter makes use of this fact to increase the memory density. The unused two cycles on the address/control bus are used to command a second device, which has a separate data bus. This reduces the pin count on each channel. It is desirable for the address/control bus and the data busses to be utilized 100% of the time and not to be idle at any time. In combining these techniques, the inventive subject matter provides SRAM-like read performance. The read sequence for an embodiment, as illustrated in the Timing Diagram, ensures that after an initial setup period of a few cycles, the data busses of each channel are always occupied.

In an embodiment represented by the above Timing Diagram, the overall DRAM system 100 operates at 375 MHz. The read operation of each instance is 62.5 MHz, and each channel 107-109 operates at 125 MHz, for a total of 375 MHz for a 3-channel system.

The address/control bus 110 is shared in common between two instances, and since four-word burst READ commands are issued to each bank and to each Instance #1 and #2, READ commands to both the instances can be interleaved to always keep 100% read utilization on the data busses 114, 116.

Thus, the inventive subject matter duplicates data (e.g. address lookup tables) across multiple banks of DRAM within any one group, to maximize the read access bandwidth to the data. A read access efficiency equivalent to that of commercially available SRAM devices may be achieved at a relatively lower cost. In addition, the number of banks can be expanded because of the relatively higher density of DRAM compared with SRAM.

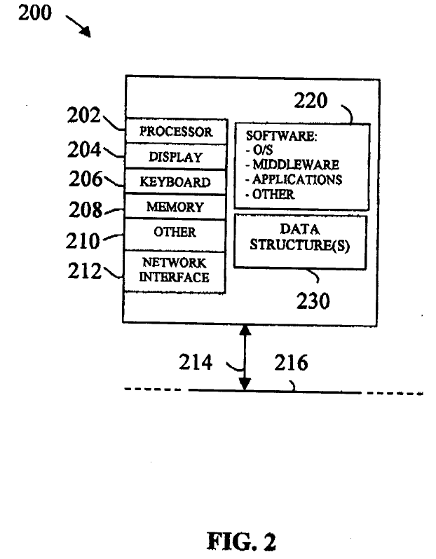

FIG. 2 is a block diagram of a computer system 200 incorporating a high-speed DRAM system, in accordance with an embodiment of the invention. Computer system 200 is merely one example of an electronic or computing system in which the inventive subject matter may be used.

Computer system 200 can be of any type, including an end-user or client computer; a network node such as a switch, router, hub, concentrator, gateway, portal, and the like; a server; and other kind of computer used for any purpose. The term “data transporter”, as used herein, means any apparatus used to move data and includes equipment of the types mentioned in the foregoing sentence.

Computer system 200 comprises, for example, at least one processor 202 that can be of any suitable type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit.

Computer system 200 further comprises, for example, suitable user interface equipment such as a display 204, a keyboard 206, a pointing device (not illustrated), voice-recognition device (not illustrated), and/or any other appropriate user interface equipment that permits a system user to input information into and receive information from computer system 200.

Computer system 200 further comprises memory 208 that can be implemented in one or more forms, such as a main memory implemented as a random access memory (RAM), read only memory (ROM), one or more hard drives, and/or one or more drives that handle removable media such as compact disks (CDs), digital video disks (DVD), floppy diskettes, magnetic tape cartridges, and other types of data storage.

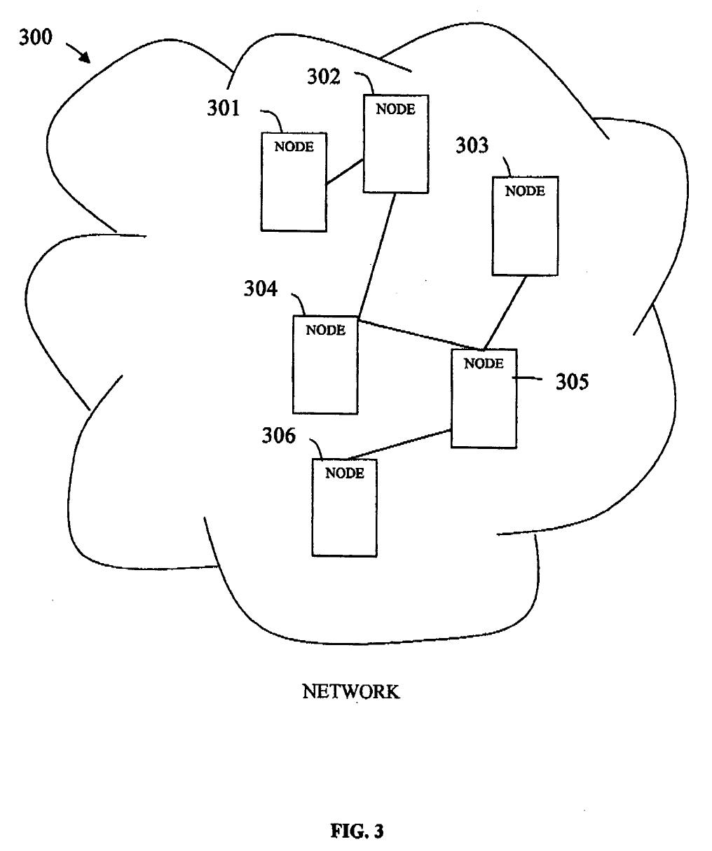

Computer system 200 further comprises a network interface element 212 to couple computer system 200 to network bus 216 via network interface bus 214. Network bus 216 provides communications links among the various nodes 301-306 and/or other components of a network 300 (refer to FIG. 3), as well as to other nodes of a more comprehensive network, if desired, and it can be implemented as a single bus, as a combination of busses, or in any other suitable manner.

Computer system 200 can also include other hardware elements 210, depending upon the operational requirements of computer system 200. Hardware elements 210 could include any type of hardware, such as modems, printers, loudspeakers, scanners, plotters, and so forth.

Computer system 200 further comprises a plurality of types of software programs, such as operating system (O/S) software, middleware, application software, and any other types of software as required to perform the operational requirements of computer system 200. Computer system 200 further comprises data structures 230. Data structures 230 may be stored in memory 208. Data structures 230 may be stored in DRAMs, such as DRAM 111 and DRAM 112 (refer to FIG. 1).

Exemplary data structures, which may contain extensive address lookup tables used by high-speed switches and routers or other types of data transporters, were previously discussed in detail above regarding FIG. 1.

FIG. 3 is a block diagram of a computer network 300 that includes a high-speed DRAM system, in accordance with an embodiment of the invention. Computer network 300 is merely one example of a system in which network switching equipment using the high-speed DRAM system of the present invention may be used.

In this example, computer network 300 comprises a plurality of nodes 301-306. Nodes 301-306 are illustrated as being coupled to form a network. The particular manner in which nodes 301-306 are coupled is not important, and they can be coupled in any desired physical or logical configuration and through any desired type of wireline or wireless interfaces.

Network 300 may be a public or private network. Network 300 may be relatively small in size, such as a two-computer network within a home, vehicle, or enterprise. As used herein, an “enterprise” means any entity organized for any purpose, such as, without limitation, a business, educational, government, military, entertainment, or religious purpose. In an embodiment, network 300 comprises an Ethernet network.

Nodes 301-306 may comprise computers of any type, including end-user or client computers; network nodes such as switches, routers, hubs, concentrators, gateways, portals, and the like; servers; and other kinds of computers and data transporters used for any purpose.

In one embodiment, nodes 301-306 can be similar or identical to computer system 200 illustrated in FIG. 2.

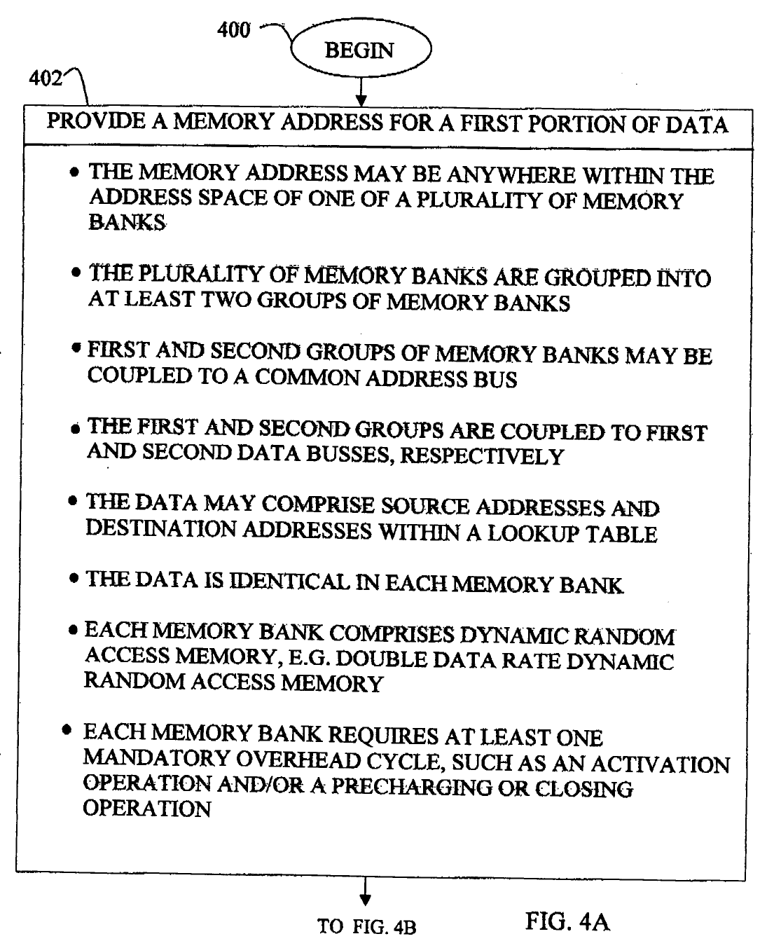

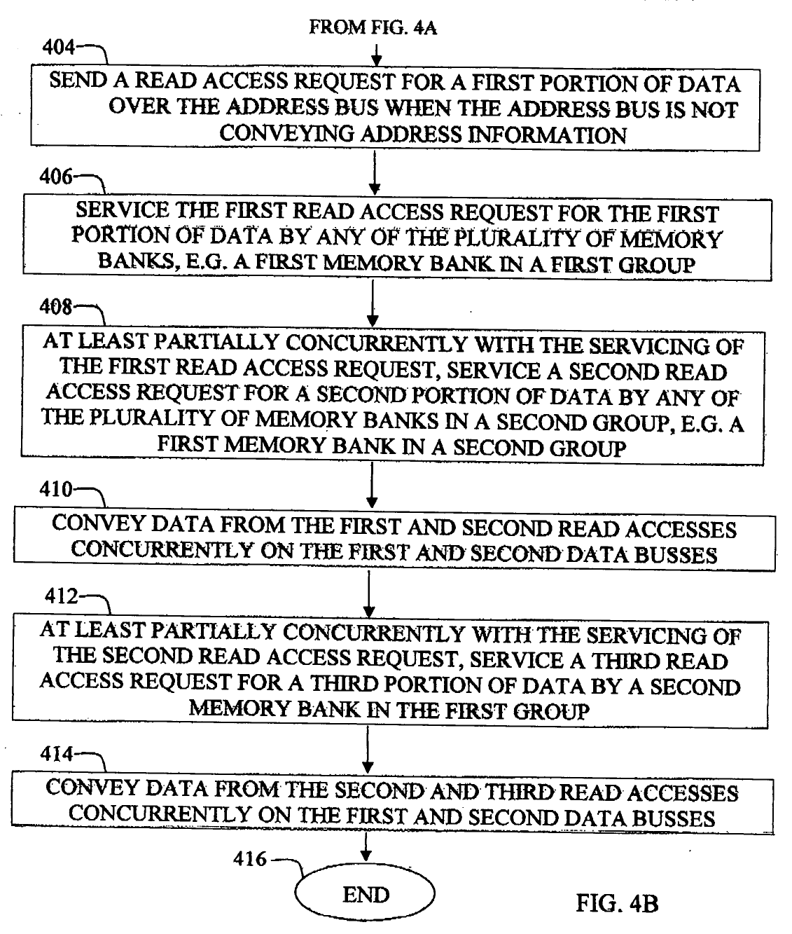

FIGS. 4A and 4B together comprise a flow diagram illustrating various methods of accessing memory in a computer system, in accordance with various embodiments of the invention. The computer system may be, for example, similar to or identical to computer system 200 shown in FIG. 2 and described previously.

Referring first to FIG. 4A, the methods begin at 400.

In 402, a memory address is provided for a first portion of data. The memory address may be anywhere within the address space of one of a plurality of memory banks. In an embodiment, a group of memory banks (e.g. four) are provided for each DRAM instance (e.g. Instance #1 and Instance #2, FIG. 1). Thus, the plurality of memory banks are grouped into at least two groups.

First and second groups of memory banks, one group per DRAM instance, may be coupled to a common address bus, e.g. address/control bus 110 in FIG. 1. The first and second groups of memory banks may also be coupled to first and second data busses, respectively, such as data busses 114 and 116 in FIG. 1.

In an embodiment, the data may comprise source and destination addresses within a lookup table maintained by a high-speed switch or router in an Ethernet network. However, in other embodiments, the data may comprise any other type of data, and any type of data transporter may be used.

The data is identical within each memory bank of the plurality of memory banks. As mentioned earlier, a suitable duplicator agent may be used to write identical data in each of the memory banks.

In an embodiment, each group of memory banks forms part of a double data rate dynamic random access memory (DDR DRAM). The memory bank of a DDR DRAM requires at least one mandatory overhead cycle to operate. The mandatory overhead cycle typically comprises an activation operation and/or a precharging or closing operation, as described previously herein.

Referring now to FIG. 4B, in 404, a read access request is sent over the address bus when the address bus is not being used to convey address information. The read access request may be for a first portion of data.

In 406, the first read access request is serviced by any of the plurality of memory banks, e.g. a first memory bank of a first group.

In 408, a second read access request for a second portion of data may be sent over the address bus, again when the address bus is not being used to convey address information. The second read access request is serviced at least partially concurrently with the servicing of the first read access request.

The second read access request may be serviced by any of the plurality of memory banks in a second group. For example, the second read access request may be serviced by a first memory bank of a second group.

In 410, data is conveyed from the first and second read accesses concurrently on the first and second data busses.

In 412, a third read access request for a third portion of data is sent over the address bus, again when the address bus is not being used to convey address information. The third read access request is serviced at least partially concurrently with the servicing of the second read access request. The third read access request is serviced by any of the plurality of memory banks in the first group except the memory bank that serviced the first read access request, if that memory bank is still active in servicing the first read access request or if it is currently inaccessible due to mandatory overhead operations. For example, the third read access request may be serviced by a second memory bank of the first group.

In 414, data is conveyed from the second and third read accesses concurrently on the first and second data busses.

In 416, the methods end.

It should be noted that the methods described herein do not have to be executed in the order described or in any particular order. Moreover, various activities described with respect to the methods identified herein can be executed in serial or parallel fashion. In addition, although an “end” block is shown, it will be understood that the methods may be performed continuously.

The methods described herein may be implemented in hardware, software, or a combination of hardware and software.

Upon reading and comprehending the content of this disclosure, one of ordinary skill in the art will understand the manner in which one or more software programs may be accessed from a computer-readable medium in a computer-based system to execute the methods described herein. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well-known to those skilled in the art, such as application program interfaces or inter-process communication techniques, including remote procedure calls. The teachings of various embodiments are not limited to any particular programming language or environment, including Hypertext Markup Language (HTML) and Extensible Markup Language (XML). Thus, other embodiments may be realized.

For example, the computer system 200 shown in FIG. 2 may comprise an article that includes a machine-accessible medium, such as a read only memory (ROM), magnetic or optical disk, some other storage device, and/or any type of electronic device or system. The article may comprise processor 202 coupled to a machine-accessible medium such as memory 208 (e.g., a memory including one or more electrical, optical, or electromagnetic elements) having associated information (e.g., data or computer program instructions), which when accessed, results in a machine (e.g., the processor 202) performing such actions as servicing a first read request for a first portion of data by any of a plurality of memory banks, wherein the data is identical in each memory bank. The actions may also include servicing a second read request for a second portion of data by any of the plurality of memory banks in a group other than the first group while the first read request is being serviced. One of ordinary skill in the art is capable of writing suitable instructions to implement the methods described herein.

FIGS. 1-3 are merely representational and are not drawn to scale. Certain proportions thereof may be exaggerated, while others may be minimized. FIGS. 1-3 are intended to illustrate various embodiments of the inventive subject matter that can be understood and appropriately carried out by those of ordinary skill in the art.

The inventive subject matter provides for one or more methods to enable SRAM-like read access speeds on DRAMs for read-intensive memory applications. A memory circuit, data transporter, and an electronic system and/or data processing system that incorporates the inventive subject matter can perform read accesses at SRAM-like speed at relatively lower cost and at relatively higher density than comparable SRAM systems, and such apparatus may therefore be more commercially attractive.

As shown herein, the inventive subject matter may be implemented in a number of different embodiments, including a memory circuit, a data transporter, and an electronic system in the form of a data processing system, and various methods of operating a memory. Other embodiments will be readily apparent to those of ordinary skill in the art after reading this disclosure. The components, elements, sizes, characteristics, features, and sequence of operations may all be varied to suit particular system requirements.

For example, different memory architectures, including different DRAM sizes, speeds, and pin-outs, may be utilized. For example, in an embodiment, the data structures are 192 bits wide, so a DDR-DRAM device with a 24-bit data bus may be used with a four-cycle burst read operation, and the device returns 192 bits in four cycles.

As a further embodiment, data need not necessarily be duplicated in each bank. If data accesses are equally distributed among different banks (using a hash function, for instance) the overall method will still work, assuming that requests for different banks are statistically uniformly distributed among banks and properly scheduled.

As an example of one such embodiment, assume that we have a table T that needs to be accessed on read. As explained earlier, we may have eight copies of T distributed on eight different banks. Alternatively, we may distribute them with a hash function H defined as follows:
if H(T[i])=0 then T[i] will be stored in bank 0;
if H(T[i])=1 then T[i] will be stored in bank 1;
if H(T[i])=2 then T[i] will be stored in bank 2; and
if H(T[i])=3 then T[i] will be stored in bank 3;
wherein i=0, . . . , MEM_SIZE−1; and
wherein MEM_SIZE represents the number of items of a given size in table T.

Assuming that H is an efficient hash function, it will distribute the data across the banks substantially uniformly.

When access is desired to an entry T[i], then B=H(T[i]) is calculated to determine to which bank the read access should be sent to.

We may queue requests to different banks and utilize the same mechanism to perform read accesses on the memory, so that the memory is operated with relatively high efficiency. If accesses come uniformly distributed to all banks, all banks will get similar amounts of requests, and all of the bandwidth of the memory will be properly used.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the inventive subject matter. Therefore, it is manifestly intended that embodiments of the inventive subject matter be limited only by the claims and the equivalents thereof.

It is emphasized that the Abstract is provided to comply with 37 C.F.R. §1.72(b) requiring an Abstract that will allow the reader to ascertain the nature and gist of the technical disclosure. It is submitted with the understanding that it will not be used to interpret or limit the scope or meaning of the claims.

In the foregoing Detailed Description, various features are occasionally grouped together in a single embodiment for the purpose of streamlining the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A method comprising:
servicing a first read request for a first portion of data by any of a plurality of memory banks, wherein the data is identical in each memory bank.

2. The method recited in claim 1 wherein, in servicing, each memory bank comprises dynamic random access memory.

3. The method recited in claim 1 wherein, in servicing, each memory bank requires at least one mandatory overhead cycle.

4. The method recited in claim 3, wherein the at least one mandatory overhead cycle comprises one of an activation operation and a closing operation.

5. The method recited in claim 1 wherein, in servicing, the data comprises source addresses and destination addresses within a table.

6. The method recited in claim 1, wherein each memory bank comprises an address space, and wherein the method further comprises prior to servicing:
providing a memory address for the first portion of data, wherein the memory address may be anywhere within the address space.

7. The method recited in claim 1 and further comprising:
servicing a second read request for a second portion of data by any of the plurality of memory banks except the memory bank that serviced the first read request.

8. The method recited in claim 1 wherein, in servicing, the plurality of memory banks are grouped into at least two groups of memory banks, wherein the first read request is serviced by a memory bank in a first group, and wherein the method further comprises:
servicing a second read request for a second portion of data by any of the plurality of memory banks in a group other than the first group while the first read request is being serviced.

9. The method recited in claim 1 wherein, in servicing, the plurality of memory banks are grouped into a plurality of groups, wherein the first read request is sent to a first group, wherein the first read request for the first portion of data is serviced by a memory bank in the first group, and wherein the method further comprises:
sending a second read request to a second group; and
servicing the second read request for a second portion of data by a memory bank in the second group at least partially concurrently with the servicing of the first read request.

10. The method recited in claim 9 and further comprising:
sending a third read request to the first group; and
servicing the third read request for a third portion of data by a memory bank in the first group while the second read request is being serviced.

11. The method recited in claim 9, wherein the first and second groups are coupled to a common address bus, and wherein the method further comprises:
sending a read request over the address bus when the address bus is not conveying address information.

12. The method recited in claim 9, wherein the first and second groups are coupled to first and second data busses, respectively, and wherein the method further comprises:
conveying data concurrently on the first and second data busses.

13. A memory circuit comprising:
first and second dynamic random access memories, each of the memories to store identical data;
a common address/control bus coupled to the memories to provide control and address signals thereto;
a first data bus coupled to the first memory to convey first data thereto and to access the first data therefrom; and
a second data bus coupled to the second memory to convey thereto data identical to the first data and to access the data therefrom.

14. The memory circuit recited in claim 13, wherein each memory comprises a plurality of internal memory banks, and wherein the first data is duplicated in each of the internal memory banks.

15. The memory circuit recited in claim 14, wherein each memory comprises four internal memory banks.

16. The memory circuit recited in claim 13, wherein each memory comprises a double data rate dynamic random access memory.

17. A memory circuit comprising:
first and second memories, each of the memories to store identical data, and each of the memories requiring at least one mandatory overhead cycle;
a common address/control bus coupled to the memories to provide control and address signals thereto;
a first data bus coupled to the first memory to convey first data thereto and to access the first data therefrom; and
a second data bus coupled to the second memory to convey thereto data identical to the first data and to access the data therefrom.

18. The memory circuit recited in claim 17, wherein each memory comprises a plurality of internal memory banks, and wherein the first data is duplicated in each of the internal memory banks.

19. The memory circuit recited in claim 18, wherein each memory comprises four internal memory banks.

20. The memory circuit recited in claim 17, wherein each memory comprises a double data rate dynamic random access memory.

21. The memory recited in claim 17, wherein the at least one mandatory overhead cycle comprises one of an activation operation and a closing operation.

22. A data transporter to use in a network comprising a plurality of nodes, the data transporter comprising:
a system bus coupling components in the data transporter;
a processor coupled to the system bus;
a memory controller coupled to the system bus; and
a memory coupled to the system bus, wherein the memory includes
first and second dynamic random access memories, each of the dynamic random access memories to store identical data;
a common address/control bus coupled to the dynamic random access memories to provide control and address signals thereto;
a first data bus coupled to the first dynamic random access memory to convey first data thereto, and to access the first data therefrom; and
a second data bus coupled to the second dynamic random access memory to convey thereto data identical to the first data, and to access the data therefrom.

23. The data transporter recited in claim 22, wherein each dynamic random access memory comprises a plurality of internal memory banks, and wherein the first data is duplicated in each of the internal memory banks.

24. The data transporter recited in claim 23, wherein each dynamic random access memory comprises four internal memory banks.

25. The data transporter recited in claim 22, wherein each dynamic random access memory comprises a double data rate dynamic random access memory.

26. An electronic system comprising:
a system bus coupling components in the electronic system;
a display coupled to the system bus;
a processor coupled to the system bus;
a memory controller coupled to the system bus; and
a memory coupled to the system bus, wherein the memory includes
first and second dynamic random access memories, each of the dynamic random access memories to store identical data;
a common address/control bus coupled to the dynamic random access memories to provide control and address signals thereto;
a first data bus coupled to the first dynamic random access memory to convey first data thereto, and to access the first data therefrom; and
a second data bus coupled to the second dynamic random access memory to convey thereto data identical to the first data, and to access the data therefrom.

27. The electronic system recited in claim 26, wherein each dynamic random access memory comprises a plurality of internal memory banks, and wherein the first data is duplicated in each of the internal memory banks.

28. The electronic system recited in claim 27, wherein each dynamic random access memory comprises four internal memory banks.

29. The electronic system recited in claim 26, wherein each dynamic random access memory comprises a double data rate dynamic random access memory.

30. An article comprising a computer-accessible medium containing associated information, wherein the information, when accessed, results in a machine performing:
servicing a first read request for a first portion of data by any of a plurality of memory banks, wherein the data is identical in each memory bank.

31. The article recited in claim 30 wherein, in servicing, the plurality of memory banks are grouped into at least two groups of memory banks, wherein the first read request is serviced by a memory bank in a first group, and wherein the method further comprises:
servicing a second read request for a second portion of data by any of the plurality of memory banks in a group other than the first group while the first read request is being serviced.

32. The article recited in claim 30 wherein, in servicing, each memory bank comprises dynamic random access memory.

33. The article recited in claim 30 wherein, in servicing, the data comprises source addresses and destination addresses within a table.

34. A memory circuit comprising:
first and second dynamic random access memories, each of the memories to store first data and second data, respectively, wherein the first data and second data together comprise overall data uniformly distributed between the first and second dynamic random access memories according to a hash function;
a common address/control bus coupled to the memories to provide control and address signals thereto;
a first data bus coupled to the first memory to convey first data thereto and to access the first data therefrom; and
a second data bus coupled to the second memory to convey second data thereto and to access the second data therefrom.

35. The memory circuit recited in claim 34, wherein each memory comprises a plurality of internal memory banks, wherein the first data is uniformly distributed among the plurality of internal memory banks of the first memory, and wherein the second data is uniformly distributed among the plurality of internal memory banks of the second memory.

36. The memory circuit recited in claim 34, wherein each memory comprises four internal memory banks.

37. The memory circuit recited in claim 34, wherein each memory comprises a double data rate dynamic random access memory.
